(19) United States
(12) Patent Application Publication
(10) Pub. No.: US 2016/0313753 A1
(43) Pub. Date: Oct. 27, 2016

(54) Sustainable Demand Control Device and Method

(71) Applicant: Mingsheng Liu, Omaha, NE (US)

(72) Inventor: Mingsheng Liu, Omaha, NE (US)

(21) Appl. No.: 15/136,967

(22) Filed: Apr. 24, 2016

Related U.S. Application Data
(60) Provisional application No. 62/151,528, filed on Apr. 23, 2015.

(51) Int. Cl. G05D 23/19; G05B 15/02

(52) U.S. Cl. CPC G05D 23/1917; G05B 15/02

(57) ABSTRACT

A system and method of controlling a temperature setpoint offset value over a period of time for either optimizing a total energy consumption rate or controlling peak demand during a peak demand time period in a facility having an existing HVAC system. The method comprises providing a control device in signal communication with said existing HVAC system. The method further comprises selecting, by a user, a plurality of parameters comprising at least a thermal capacity parameter corresponding to said facility, and a control schedule parameter configured to control the temperature setpoint offset value during the peak demand time period. During the peak demand period, the control device is configured to modulate the room temperature setpoint offset value from a low limit to a high limit based on the user selected control schedule parameter.

### CROSS-REFERENCE TO RELATED APPLICATIONS

This application claims the benefit of U.S. Provisional Patent Application Ser. No. 62/151,528 filed on Apr. 23, 2015.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The disclosed embodiments generally relate to controlling peak energy demand in HVAC applications and more particularly to controlling peak demand periods using single zone roof top units, single zone heat pump units, VAV terminal boxes for large air handling units, fan coil units, single duct VAV air handling units, dual duct VAV air handling units, and rooftop DX VAV air handling units.

### DESCRIPTION OF THE RELATED ART

Peak demand management is a way to limit the use of electricity during peak-use periods when usage is high. It has been shown to significantly make power generation more efficient and lower the number of needed capital investments in energy infrastructure. Examples of energy demand management solutions include turning off lights in commercial buildings and air-conditioning units in residential homes. One way to manage peak demand is through load shifting, or the movement of the mass generation capacity from one grid to another. In the prior art, several energy demand management strategies for managing peak demand have been employed with varied success. For example, thermal energy storage is a strategy that has been implemented in the prior art to manage peak demand in commercial buildings. In the thermal energy storage method, chilled water or ice is produced during off peak periods (in the evening or morning) so that it can be used to lower energy use during periods of peak usage. Since there are typically no or just a few chillers in operation during peak demand time periods, peak demand can be reduced drastically. Unfortunately, the system has some drawbacks. For one, creating the thermal energy storage system involves a considerable cost investment. The system itself is complex and the payback period tends to take 4 or more years. Due to the uncertainty of the demand charge, in reality very few thermos storage systems are built. Very few facilities can be implemented with the thermal energy storage system as a result of the limitations brought about by its physical structure. In addition, the amount of energy consumed is often increased instead of reduced due to heat loss.

Another method introduced in the prior art to reduce peak demand is to modify the room temperature. If the room temperature is reset to a higher value, the ratio of the peak demand over the peak demand period lowers. At the beginning of the peak demand period, the room temperature is often increased by at least 2° F. This method is intended for short peak demand periods since it is not as effective when peak demand periods are longer. Finally, while it is well-documented that energy can be saved as a result of pre-cooling the building at night with natural air, the excessive moisture introduced into the building is not always practical. Technologies that use night pre-cooling tend to be hard to integrate with the control systems of existing air handling units. They also do little to impact the amount of electricity consumed at peak time periods and tend to create excessive reheat.

When electricity usage is shifted to off-peak time periods, clients can lower their energy costs and possibly avoid the higher rates that utilities charge during on-peak time periods. A sustainable demand control system is thus described herein to accomplish this task and to remedy the issues present in the prior art. As an add-on controller, the proposed system can be easily implemented in new or already existing HVAC control systems at a minimal cost. Implementation of the proposed system does not affect the configuration of the existing HVAC system nor interrupt its normal mechanical operations. The proposed system has been implemented with a variety of control options that accommodate a variety of electricity use patterns. The user can select the control option that is the most cost effective for his/her building based on the requirements of the building and utility. It implements the chosen option, intelligently controlling the peak demand period to lower energy costs. The proposed system can also be set to a default setting that automatically selects the building peak demand control schedule that is the best fit (in terms of saved energy and costs) for the particular building requirements.

Accordingly, it is one aspect of an embodiment to utilize the characteristics of the building thermal capacity (heavy, medium, light) to maximize energy savings.

It is another aspect of an embodiment to control the peak demand period and maintain the room temperature at a pre-defined range without the need for routine maintenance.

It is a further aspect of an embodiment to provide sustainable and significant peak control of the peak demand period without the need for a dedicated DR (demand response) system.

### SUMMARY OF THE INVENTION

The following summary of the invention is provided to facilitate an understanding of some of the innovative features unique to an embodiment of the present invention and is not intended to be a full description. A full appreciation of the various aspects of the invention can be gained by taking the entire specification, claims, drawings, and abstract as a whole.

In an embodiment, a system and method for controlling a temperature setpoint offset value over a period of time for either minimizing a total energy consumption rate or minimizing the peak demand during a peak demand time period in a facility having an existing HVAC system is proposed. In the method, a control device is provided in signal communication with the existing HVAC system that is operable to receive a plurality of system parameters from the existing HVAC system comprising at least a maximum room temperature off-set value. In the method, a user selects from an interface of the control device a plurality of parameters comprising at least a thermal capacity parameter corresponding to the facility, and a control schedule parameter configured to control said temperature setpoint offset value. In the method, the control device initiates the selected control schedule parameter and maintains the room temperature set point off-set at an initial value over a first predetermined period of time. In the method, the control device then resets the room temperature set point offset based on the selected building thermal capacity parameter over a second predetermined period of time. The control device maintains the room temperature setpoint offset value at a setpoint value minus the maximum room temperature offset value over a third predetermined period of time. In the system and method, the control device modulates the room temperature setpoint offset value from a low limit to a high limit based on the control schedule parameter that the user selected during the peak demand time period. When the peak demand time period is over, the control device is then configured to reset the room temperature setpoint offset value to decrease an HVAC load value below a predetermined ratio over a fifth period of time. The control device then resets the room temperature setpoint offset value to the initial value over a sixth period of time. In a method of the embodiment, the user selects the control schedule parameter configured to control the temperature setpoint offset value to minimize the total energy consumption rate during the peak demand time period. In another method of the embodiment, the user selects the control schedule parameter configured to control the temperature setpoint offset value to minimize the peak demand during the peak demand time period. In yet another method of the embodiment, the user selects the control schedule parameter for controlling the room temperature setpoint offset at the default schedule so that the offset increases linearly during the peak demand time period.

In embodiments in which the HVAC system is an air handling unit, the plurality of parameters corresponding to said peak demand time period further comprise an average airflow measurement setpoint taken from the air handling unit prior to said peak demand time period. In the stated method, (in which the HVAC system is an air handling unit), the user can select the control schedule that minimizes the peak demand during the peak demand time period. The controller modulates the temperature offset value between a minimum and maximum limit to maintain the temperature offset value during said period of peak demand. In the method and embodiment in which the HVAC system is an air handling unit, the user can alternatively select the control schedule parameter that is configured to minimize the total energy consumed over the peak demand period.

The above-described summary, features, and advantages of the present disclosure thus improve upon aspects of those systems and methods in the prior art designed to control the temperature of a space. Other aspects will become apparent by consideration of the detailed description.

It will be appreciated that for simplicity and clarity of illustration, elements illustrated in the following figures have not necessarily been drawn to scale. For example, the dimensions of some of the elements are exaggerated relative to other elements for clarity. Advantages, features, and characteristics of the present disclosure, as well as the methods, operation, and functions of the related elements of structure, and the combination of parts and economies of manufacture, will become apparent upon consideration of the following description and claims with reference to the accompanying drawings, all of which form a part of the specification, wherein like reference numerals designate corresponding parts in the various figures, and wherein:

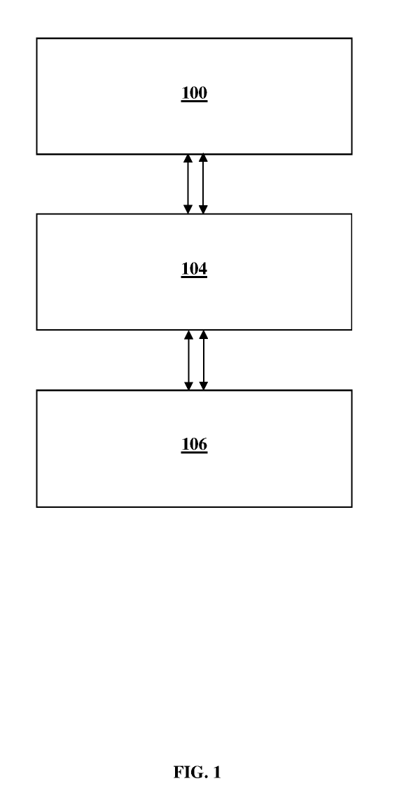

FIG. 1 is a schematic diagram of the control system implemented in a single zone rooftop unit.

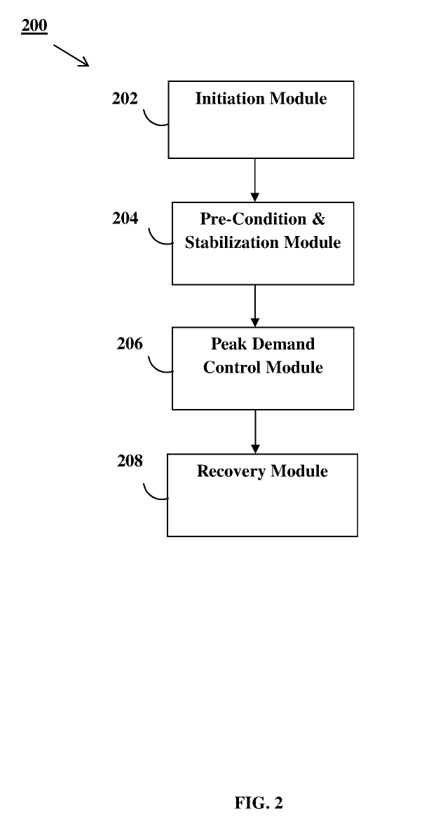

FIG. 2 is a flowchart showing the decision-making processes of the system used for controlling peak demand.

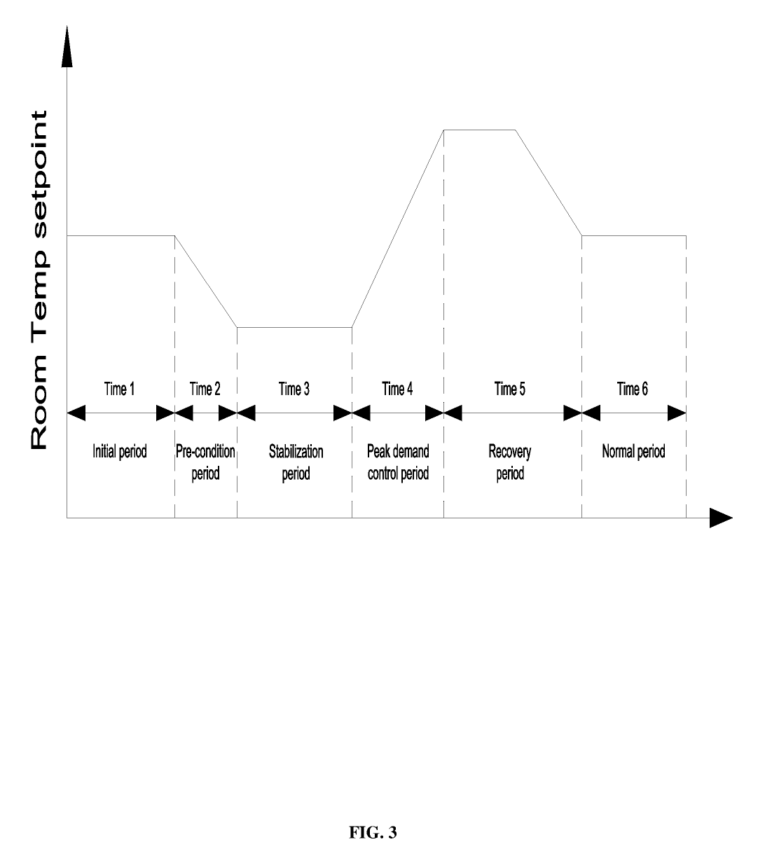

FIG. 3 is a graph showing the room temperature set point over a set interval of time that corresponds to each control phase.

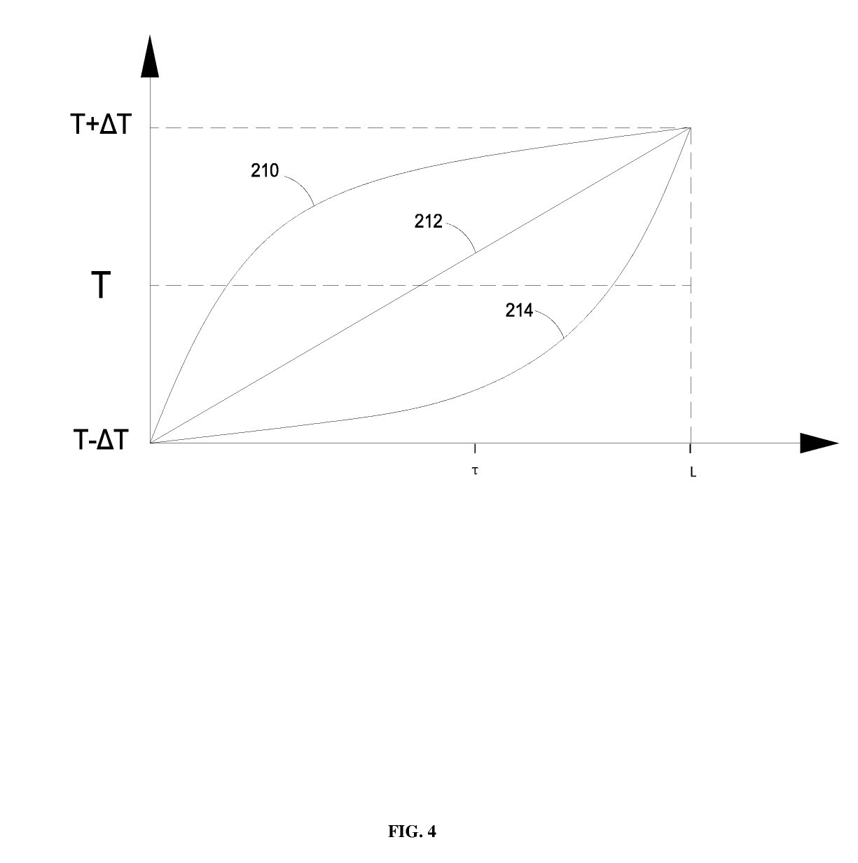

FIG. 4 is a graph that compares the control schedules that can be selected to operate during the peak demand time period.

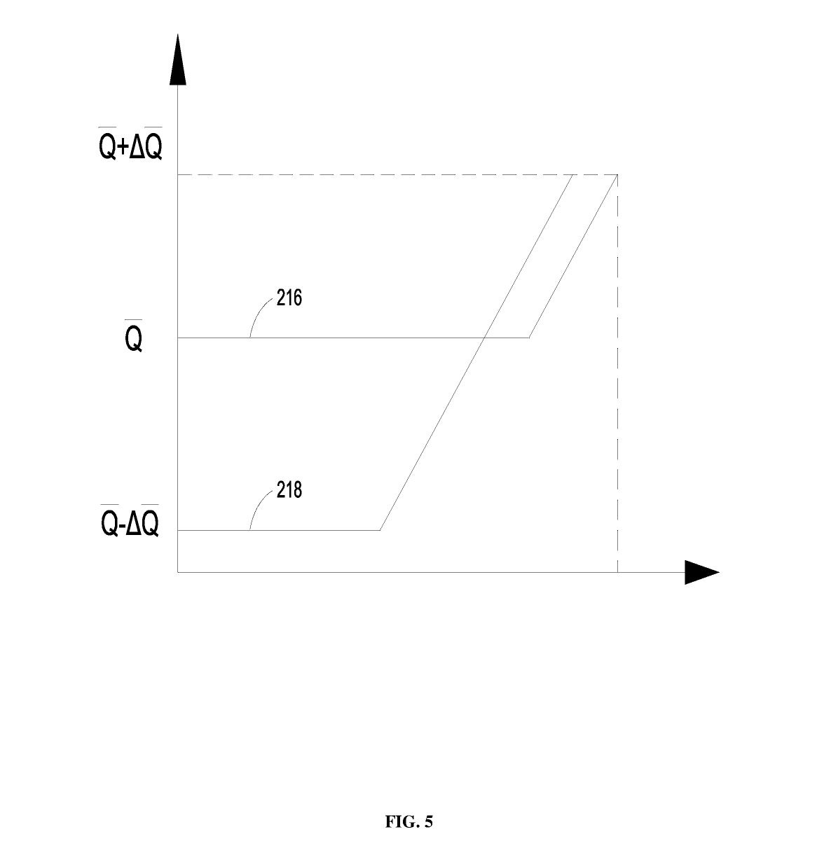

FIG. 5 is a graph that compares the control schedules that can be selected to operate during the peak demand time period when the control system is configured in connection to an air handling unit.

### DRAWINGS REFERENCE NUMERALS

100 Sustainable Peak Demand Controller System
104 BAS Controller
106 HVAC Unit Controller
200 Sustainable Peak Demand System Control Logic
202 Initiation Module
204 Pre-Condition & Stabilization Module
206 Peak Demand Control Module
208 Recovery Module
210 Control Schedule 1 Curve
212 Control Schedule 2 Curve
214 Control Schedule 3 Curve
216 Control Schedule 4 Curve
218 Control Schedule 5 Curve

### DETAILED DESCRIPTION

Before the present methods, systems, and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. It must also be noted that as used herein and in the appended claims, the singular forms “a”, “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments, the preferred methods, materials, and devices are now described. Nothing herein is to be construed as an admission that the embodiments described are not entitled to antedate such disclosure by virtue of prior invention.

FIG. 1 is a schematic diagram illustrating the implementation of sustainable peak demand control device 100 in an existing HVAC unit. Control device 100 is connected in signal communication with BAS (Building Automation System) Controller 104 and the local controller of the existing HVAC unit (HVAC Controller 106). BAS Controller 104 can be part of the existing HVAC System in which Control device 100 is to be implemented. While in the provided Figure (FIG. 1) Controller 106 is a controller for a single zone rooftop unit, in other embodiments, Controller 106 can be a controller for a heat pump or a VAV terminal box for AHUs and/or fan coil units (but is not limited to the stated applications). In the method, sustainable peak demand control device 100 receives signals from BAS Controller 104 that are indicative of the parameters of the existing building system to include the outside air temperature values, maximum room temperature off-set values, and the enable or disable demand response signals. (The maximum room temperature off-set is defined herein as the bias of the room temperature from the room temperature set point and is generally set at or around 2 or 3 degrees Fahrenheit depending on the needs of the occupants). A thermostat can also be used in place of BAS Controller 104 in some embodiments. In addition, in some embodiments control device 100 can be configured to receive the enable and disable demand response signals from the controllers of the other mentioned existing building systems (heat pump, VAV terminal box controller, etc.).

Controller 100 is pre-set by the user with a set of user parameters for the building in which it will be implemented. Typically, in order to save energy, the user inputs parameters into controller 100 that most closely correspond with the period of time that the building (in which it is implemented) consumes the largest amount of electricity. The programmable user parameters are: the building type; the on-peak hours; the start and end dates of the peak demand period for the building (the calendar dates in which the peak demand control method takes effect and ends); and the peak demand control schedule type. These parameters are explained in more detail in the following. The building type refers to the heat storage capacity of the building materials (of the building in which controller 100 is implemented). It can be pre-set by the user as either “heavy”, “medium”, or “light”. For example, a building denoted as having a “heavy” building type is a building predominantly comprised of heavy materials such as concrete, and/or brick.

The on-peak hours either denote the hours in a day in which the facility electricity costs are the highest or the amount of electricity consumed is near the peak demand. Information on the on-peak hours is typically provided to the user by the electrical utility and depends on the rate schedule that the utility uses for the particular building. However, the user can also look at the daily electrical use patterns of the building where device 100 is implemented to determine the on-peak hours. The peak demand control schedule is the user selectable peak demand period control schedule (see the possible schedules denoted in FIGS. 4 & 5) for device 100. Device 100 can be configured to either minimize the peak demand over a 15 minute moving window over the peak demand period, or to reduce the entire amount of energy consumed over the entire peak demand period. Based on these input parameters and the signals received from BAS controller 104, Controller 100 implements the procedure described in FIG. 2. Controller 100 then sends signals to BAS Controller 104 to set the room temperature set point off-set.

FIG. 2 illustrates control logic 200 of sustainable demand control system 100. FIG. 3 illustrates how the room temperature setpoint changes during each control phase as a result of the function of the room temperature setpoint offset. Control logic 200 begins with Initiation Module 202. There are a variety of ways by which control logic 200 of controller 100 can be initiated. In one embodiment, control logic 200 can be initiated based on the parameters preset by the user and the signals received from BAS controller 104. In another embodiment, control logic 200 can be initiated by an enable/ disable signal sent directly from BAS controller 104 to controller 100. In yet another embodiment, controller 100 can be pre-programmed by the user to automatically begin operating on days when the building consumes more electricity than usual. In still yet another embodiment, control logic 200 can also be intelligently initiated by the building load projection. For example, controller 100 can initiate control logic 200 on days when the outdoor air temperature is higher than the monthly average so that the building has a higher load.

The control process continues with Pre-condition & Stabilization Module 204. Module 204 sets and stabilizes the room temperature set point based on the building type that the user has selected. The pre-condition & stabilization time periods are determined according to the building type selected. Typically, the heavier the building type selected, the longer the time period lasts. During the pre-condition time period, controller 100 linearly resets the room temperature off-set over a set time interval. Generally, the time interval between each reset is around 15 minutes (however the time period of the interval is certainly not limited to that number). Over the entire time that controller 100 is in the stabilization time period, the room temperature setpoint is maintained at a minimum value (at a setpoint minus the maximum room temperature off-set (DeltaT) before the peak demand period) (see FIG. 4).

Control logic 200 continues with Peak Demand Control Module 206. However, the control method of Module 206 differs depending on the particular application with which control device 100 is implemented. When implemented in single zone roof top units, single zone heat pump units, VAV terminal boxes for large air handling units, and fan coil units, Peak Demand Control Module 206 resets the room temperature set point from a low limit to a high limit over the length of the on-peak period. This temperature set point is then normalized back to the level it was at during the initiation phase. During this time, the output of controller 106 does not go below a preset low limit (for example, a low limit might be 50% of the system capacity at any moment).

The way in which the room temperature is reset during the on-peak period depends on the control schedule selected. When device 100 is implemented in applications such as single zone roof top units, single zone heat pump units, VAV terminal boxes for large air handling units, and fan coil units, the user can select to configure control device 100 to control the room temperature according to one of the three configurable control schedules. Thus, if the ultimate goal of the user is to reduce the total energy consumption during the on-peak period, device 100 should be configured to control the room temperature so that it can be reset according to control schedule 1 curve 210 (see the labeled curve in FIG. 4). However, if the ultimate goal of the user is to reduce the peak demand period over a 15 minute moving time interval, then the room temperature should be reset according to control schedule 3 curve 214 (see the labeled curve in FIG. 4). Control schedule 2 curve 212 (see FIG. 4) is the selectable default schedule of the device.

In another embodiment, sustainable demand controller 100 can be configured to change the temperature off-set based on the airflow of the air handling unit (AHU). In this embodiment, Peak demand control module 206 modifies the peak demand period room temperature setpoint offset according to the average airflow of the AHU. In such embodiments, peak demand control module 206 preconditions the building it serves so as to maximize the cooling storage capacity of the building. It also resets the room temperature to minimize the cooling load over the peak demand period. In this method, two differing control options can be selected for controlling the airflow of the AHU.

In the said embodiment (in which sustainable demand controller 100 is configured to change the temperature off-set based on the airflow of the AHU), the user first inputs into controller 100 the average airflow of the AHU before the on-peak period. This average can be acquired from the historical operation data of the HVAC system. If the average airflow of the building before the on-peak period is not available, then the average airflow of the AHU can be determined based on the outside air temperature received from BAS controller 104. In other embodiments, the HVAC unit controlled by controller 106 can also be implemented with an outside air temperature sensor instead of BAS controller 104. In the embodiment having an outside air temperature sensor, the sensor measures the outside air temperature values and sends that information to controller 100.

Similarly, if it would be most cost efficient to minimize the peak demand during the on-peak period over a 15 minute moving window of time, the user can configure controller 100 to modulate the airflow setpoint based on control schedule 4 curve 216 (as shown in FIG. 5). If it would be most cost efficient to minimize the total energy consumption, the user can configure controller 100 to operate according to control schedule 5 curve 218 (as shown in FIG. 5). Notably, when the room temperature off-set reaches the highest possible value, the airflow can be controlled based on the supply air static pressure. As a result, it is possible that the actual airflow may be significantly higher than the set point shown in the schedule.

Once the on-peak period ends (meaning when controller 100 is no longer in control module 206) for the two embodiments for controlling peak demand period module 206, (The two embodiments referred to are the embodiment in which the temperature offset is changed based on the airflow of the AHU and the embodiment in which the room temperature offset is set based on a time interval), the control device then goes to Recovery Module 208. Recovery Module 208 re-normalizes the operation of the system. Module 208 sets the room temperature for an extended period of time to allow the load of RTU 106 to decrease below a predetermined ratio (such as a ratio of 80%, but not limited to the stated). The room temperature setpoint is then reset linearly back to the normal set point over a pre-determined period of time (such as for a period of but not limited to two hours). The control process returns to its normal operation as seen in the graph in FIG. 3.

The following describes what is shown in FIGS. 4 and 5 in more detail. The curves shown in the graph in FIG. 4 are calculated according to the following equation:

$$Δ T = 2 * Δ {{T}_{max} ( \frac{τ}{L} )}^{n} - Δ {T}_{max}$$

Where ⁿ is the exponent of the temperature setpoint offset curve of the user selected control schedule
ΔT is the temperature offset value
τ is the time calculated in minutes once the peak demand time period commences
L is the length of the peak demand time period in minutes
ΔTₘₐₓ is the maximum room temperature offset value
The value of ⁿ is based on the curve. Curve 210 can for example be found when ⁿ is equal to 0.5 (but is not limited to the stated value). Curve 214 can for example be found when ⁿ is equal to 2.5 (but is not limited to the stated value). Curve 212 is found when ⁿ is equal to 1.

Curve 214 shows that a close exponential relationship exists between the temperature offset and the peak demand time period. As shown in FIG. 4, when the peak demand period commences, the temperature offset increases at a small rate. As the peak demand time period continues, this rate gradually increases. This occurs due to the gradual increase in the building thermal load and gradual release of thermal mass stored during the pre-cooling period. If the user finds it would be most cost efficient to minimize the total energy consumption during the on-peak period, then cooling is continuously provided to the building at a low rate to compensate for the release of thermal mass stored during the precooling period. During the latter part of the peak demand time period, when the building load has further increased, the temperature offset is shown to increase at a greater rate.

As shown in FIG. 4, a close exponential relationship exists between the temperature offset and the peak demand time period for curve 210. Curve 210 has a slope that decreases over time. When the peak demand period commences, curve 210 increases at a large rate, allowing the room temperature offset to reach a value that is close to the maximum temperature offset value earlier than the other curves. Compared with the beginning of the peak demand period, curve 210 increases more gradually. Thus, the thermal mass stored during the pre-cooling period is maximized and the total energy consumption during the peak demand time period is reduced. As shown in FIG. 4, Curve 212 increases linearly from the minimum (T−ΔT) to the maximum value (T+ΔT).

The following describes the graph shown in FIG. 5 for embodiments that employ the illustrated control schedules. As shown in the graph for Curve 216, when the peak demand time period starts, the temperature offset value is modulated between a minimum and maximum value so that the airflow can be maintained at a predetermined average airflow value. Once the temperature reset reaches the maximum value, the airflow increases linearly. The temperature offset is modulated to maintain the airflow at a rate that linearly increases from the predetermined average (Q) to a value equaling the predetermined average plus delta Q, (a predetermined airflow difference). As shown in FIG. 5 by curve 218, when the peak demand time period begins, the temperature offset value is modulated between a minimum and maximum value to maintain the airflow rate at a predetermined average (Q) minus delta Q (a predetermined airflow difference) and is then linearly increased to a predetermined average (Q) plus delta Q (a predetermined airflow difference).

Therefore, it will be apparent to those skilled in the art that various modifications can be made in the system for controlling peak demand without departing from the scope or spirit of the given embodiment. Other embodiments will be apparent to those skilled in the art from consideration of the specification and practice of the disclosure in this application.

What is claimed is:

1. A method of controlling a temperature setpoint offset value for either minimizing a total energy consumption rate or minimizing peak demand during a peak demand time period in a facility having an existing HVAC system, said method comprising:
providing a control device in signal communication with said existing HVAC system operable to receive a maximum room temperature off-set value;
selecting, by a user from an interface on said control device, a plurality of parameters comprising at least a thermal capacity parameter corresponding to said facility, and a control schedule parameter configured to control said temperature setpoint offset value;
initiating, by said control device, said control schedule parameter;
maintaining, by said control device, said room temperature set point off-set value at an initial value over a first predetermined period of time;
resetting, by said control device, said room temperature set point offset based on said building thermal capacity parameter over a second predetermined period of time;
maintaining, by said control device, said room temperature setpoint offset value at a setpoint minus said maximum room temperature offset value over a third predetermined period of time;
modulating, by said control device, said room temperature setpoint offset value based on said control schedule parameter over said peak demand time period;
resetting, by said control device, said room temperature setpoint offset value to decrease a load value of said existing HVAC system below a predetermined ratio over a fifth period of time;
resetting, by said control device, said room temperature setpoint offset value to said initial value over a sixth period of time.

2. The method of claim 1, wherein said existing HVAC system is a single zone rooftop unit, single zone heat pump unit, variable air volume terminal box for a large air handling unit, or a fan coil unit.

3. The method of claim 2, wherein said control schedule parameter is configured to control said temperature setpoint offset value to minimize said total energy consumption rate over said peak demand time period.

4. The method of claim 2, wherein selecting, by said user, said control schedule parameter for controlling said room temperature setpoint offset value further comprises setting said temperature setpoint offset value to minimize said peak demand load during said peak demand time period.

5. The method of claim 2, wherein selecting, by said user, said control schedule parameter for controlling said room temperature setpoint offset value further comprises setting said temperature setpoint offset to increase linearly during said peak demand time period.

6. The method of claim 1, wherein said existing HVAC system is an air handling unit.

7. The method of claim 6, wherein said plurality of parameters corresponding to said peak demand time period further comprise an average airflow measurement setpoint taken from said air handling unit prior to said peak demand time period.

8. The method of claim 7, further comprising modulating said room temperature setpoint offset during said peak demand time period at said average airflow measurement setpoint when said user wants to minimize said peak demand load during said peak demand time period.

9. The method of claim 7, further comprising modulating said room temperature setpoint offset during said peak demand time period at said average airflow measurement setpoint when said user wants to minimize said total energy consumption during said peak demand time period.

10. The method of claim 1, wherein said building thermal capacity parameter for said facility is heavy.

11. The method of claim 1, wherein said building thermal capacity parameter for said facility is medium.

12. The method of claim 1, wherein said building thermal capacity parameter for said facility is light.

13. A controller for controlling a temperature offset value based on a control schedule parameter configured by a user to either minimize all energy consumed or minimize a peak demand load during a peak demand time period in a facility having an existing HVAC system, said controller comprising:
an interface configured to enable said user to input into said controller a plurality of parameters comprising at least a building thermal capacity parameter and said control schedule parameter;
a communication means connected to said existing HVAC system and operable to receive a maximum room temperature off-set value;
a first module configured to initiate said control schedule parameter;
a second module configured to maintain said room temperature set point off-set value at an initial value during a first predetermined period of time;
a third module configured to reset said room temperature set point off-set value based on said building thermal capacity parameter during a second predetermined period of time;
a fourth module configured to maintain said room temperature set point off-set value at a setpoint minus said maximum room temperature off-set value;
a fifth module configured to modulate said room temperature offset value based on said control schedule parameter during said peak demand time period;
a sixth module configured to reset a load of said HVAC system below a predetermined ratio;
a seventh module configured to reset said room temperature offset value to said initial value over a sixth period of time.

14. The system of claim 13, wherein said existing HVAC system is a single zone rooftop unit, single zone heat pump unit, variable air volume terminal box for a large air handling unit, or a fan coil unit.

15. The system of claim 14, wherein said control schedule parameter is configured to control said temperature setpoint offset value to minimize said total energy consumption rate over said peak demand time period.

16. The system of claim 14, wherein said control schedule parameter is configured to control said temperature setpoint offset value to minimize said peak demand load during said peak demand time period.

17. The system of claim 13, wherein said existing HVAC system is an air handling unit.

18. The system of claim 17, wherein said plurality of parameters corresponding to said peak demand time period further comprise an average airflow measurement setpoint taken from said air handling unit prior to said peak demand time period.

19. The system of claim 17, wherein said control schedule parameter is configured to modulate said room temperature setpoint offset at said average airflow measurement setpoint when said user wants to minimize peak demand during said peak demand time period.

20. The system of claim 17, wherein said control schedule parameter is configured to modulate said room temperature setpoint offset at said average airflow measurement setpoint when said user wants to control said temperature setpoint offset value to minimize said total energy consumption rate over said peak demand time period.
